(19) United States
(12) Patent Application Publication
(10) Pub. No.: US 2017/0157653 A1
(43) Pub. Date: Jun. 8, 2017

(54) SURFACE MICROSTRUCTURES

(71) Applicant: Andrew PARKER, Surrey (GB)

(72) Inventor: Andrew PARKER, Surrey (GB)

(73) Assignee: Andrew PARKER, Surrey (GB)

(21) Appl. No.: 15/309,572

(22) PCT Filed: May 8, 2015
(86) PCT No.: PCT/GB2015/051367

§ 371 Date: Nov. 8, 2016

(30) Foreign Application Priority Data
May 8, 2014 (GB) 1406469.5

(51) Int. Cl. B08B 17/06; B82Y 40/00; B82Y 30/00

(52) U.S. Cl. CPC B08B 17/06; B82Y 30/00; B82Y 40/00; B29C 2059/023

(57) ABSTRACT

A surface microstructure comprises a surface (2); and a plurality of protrusions (4) on the surface, wherein each of the protrusions has a base portion which extends away from the plane of the surface and an extending portion which extends in a direction which has a component parallel to the plane of the surface, and wherein the protrusions each have a length between 0.25 and 100 μm and a width between 0.1 and 1.5 μm.

The invention relates to a surface microstructure, in particular, but not exclusively, to a surface microstructure which is self-cleaning such as mud shedding. The surface microstructure may offer further properties such as anti-microbe, anti-fouling and/or super hydrophobic properties.

There is an increasing interest in the field of self-cleaning materials. It is known to use self-cleaning coatings on glass. These coatings are generally either hydrophobic or hydrophilic. These two types of coating both clean themselves in wet conditions; in the case of hydrophobic material by rolling droplets and in the case of hydrophilic material by sheeting water that carries away dirt.

It is desired to provide novel surface microstructures which have self-cleaning properties.

In a first aspect, the present invention provides a surface microstructure, the surface microstructure comprising: a surface; and a plurality of protrusions on the surface, wherein each of the protrusions has a base portion which extends away from the plane of the surface and an extending portion which extends in a direction which has a component parallel to the plane of the surface, and wherein the protrusions each have a length between 0.25 and 100 μm and a width between 0.1 and 1.5 μm.

This surface microstructure can have advantageous self-cleaning properties. In particular, the microstructure may promote mud-shedding, especially in damp conditions. This means that dirt may fall away from the surface or can easily be washed off. Additionally and/or alternatively, the surface may be an anti-microbe and/or anti-fouling surface (i.e. have a tendency to expel living things, or to prevent multi-celled bodies from being able to attach to the surface). Additionally or alternatively, the surface microstructure may be super-hydrophobic.

The surface is a man-made surface and the protrusions may be formed on or from the man-made surface. The surface microstructure may be an artificial and/or an industrially prepared structure. The protrusions may be fibrils.

The surface may be the outer or upper surface of a substrate, for example, provided on a flexible sheet of material. The surface may also be a surface of a fiber.

Given these advantageous properties, the surface microstructure may be applied to articles or objects in which it is desirable to have such self-cleaning and/or super-hydrophobic properties.

The surface microstructure according to the present invention may be used on a number of different articles. A non-exhaustive list includes apparel or garments including clothing (e.g., outdoor clothing, protective clothing, etc) and footwear, such as boots and sports shoes.

As an example, the surface microstructure may be used on the sides or the sole of a sport shoe, such as a trainer, running shoe, football boot, rugby boot, etc., or other footwear that are likely to be used in muddy conditions. With this example, the microstructure can act to help keep the shoe looking clean, even after use in muddy environments.

The microstructure may also be present on the inside surface of containers such as jars, cans or bottles to aid emptying the contents of the container. The containers may be used in a number of different applications such as food containers, medical containers, paint containers etc.

The microstructure may be arranged so that the extending portions of the protrusions extend towards the opening of the container to aid the movement of the contents leaving the container. This means that it is possible for less product to be wasted due to residue in a container at the end of its life.

Thus, in a second aspect, the present invention provides an article which comprises a surface microstructure, the surface microstructure comprising: a surface; and a plurality of protrusions on the surface, wherein each of the protrusions has a base portion which extends away from the plane of the surface and an extending portion which extends in a direction which has a component parallel to the plane of the surface, and wherein the protrusions each have a length between 0.25 and 100 μm and a width between 0.1 and 1.5 μm.

The surface microstructure may be provided on a surface of the article so as to provide the article with self-cleaning, anti-microbe, anti-fouling and/or super hydrophobic properties.

The extending portion extends in a direction which has a component parallel to the plane of the surface. This means that the extending portion may extend at an angle from −10 to 70° relative to the plane of the surface, the negative angle indicating that the extending portion may project slightly back towards the surface within this range and the positive angle indicating that the extending portion may project at an angle away from the surface. Preferably the extending portion extends at an angle from −5 to 45°, more preferably −5 to 20° to the surface. The extending portion may extend at an angle of less than 5° relative to the surface.

The extending portion may extend in a direction which is essentially parallel to the plane of the surface, i.e. at 0°±10° and more preferably 0°±5° to the surface. The extending portion may not be strictly parallel to the plane surface of the surface and thus may extend away or towards the surface.

The base portion extends generally away from the surface, preferably out of the surface, and at an angle which is different to the angle at which the extending portion extends. The base portion extends at an angle relative to the surface which is greater than the angle at which the extending portion extends relative to the surface. The protrusions may have a generally angular shape, for example, an L or T-shape. The protrusions could also have a gradually changing angle of extension from the base portion to the extending portion, e.g. the protrusion may be curved when viewed from the side.

The base portion may extend at an angle relative to the surface which is between 5 and 90°, 45 to 90° or greater than 75°, i.e., it may extend in a direction which has a minor component parallel to the plane of the surface, this being in any direction, though preferably in the same or substantially the same forward direction as the extending portion. The base portion may extend perpendicular (i.e. at 90°±10°) to the plane of the surface. The base portion may even be angled slightly sideways or backwards away from the extending portion.

The extending portion may be directly attached to the base portion, i.e. without any portions intermediate the extending portion and the base portion. The protrusion may be a single part comprising the base portion and the extending portion. The base portion and the extending portion may be contiguous. The extending portion may only be connected to another portion at one end, i.e. one end of the extending portion is not connected to any portion. In other words the extending portion has a free end. The base portion may be connected to the extending portion generally along its length, i.e. not at one end. This could mean that the extending portion has two free ends.

The base portion may extend out of the plane of the surface. In other words, the base portion may be directly in contact with the surface at one end. The base portion may be integral with the surface (e.g. formed directly from the surface) or attached directly to the surface, such as by adhesive or welding. In this case, each protrusion may consist of a base portion which extends directly from the surface and an extending portion which is attached directly to or integral with the base portion. In this case, the extending portion may have one end which is directly attached or integral with the base portion and one free end.

Alternatively, the surface microstructure may further comprise a plurality of support portions. For example, each protrusion may further comprise a support portion. The support portion may be provided between the surface and the base portion. The support portion may be may be integral with the surface (e.g. formed directly from the surface) or attached directly to the surface, such as by adhesive or welding. The base portion may be attached directly to or be integral with the support portion and the extending portion may be attached directly to or be integral with the base portion. In this case, the extending portion may have one end which is directly attached or integral with the base portion and one free end.

When each protrusion comprises a support portion the protrusions may each be a three-tiered structure, i.e. the protrusion comprises or consists of three levels formed by the support portion, the base portion and the extending portion. Each protrusion may consist of a support portion extending from the surface, a base portion mounted on the support portion and an extending portion leading to a free end. In one configuration, these portions correspond to respective thirds of the protrusion, i.e., a first third is the support portion, a second third is the base portion and a final third is the extending portion.

Each support portion preferably defines a hollow structure through which a fluid, such as water or air, can flow or be trapped. Each support portion may comprise a plurality of legs which extend away from or out of the surface and are connected to define a hollow support structure. For example, each support portion may be a loop structure, e.g. a structure formed from two legs that extend out of the surface and are connected to form a loop. Alternatively, each support structure may comprise three legs which extend out of the surface and are connected to form a pyramidal base structure. The support portion may comprise more than three legs.

The protrusions may each have substantially the same dimensions, they may all extend in substantially the same direction and/or they may extend at substantially the same angles. Preferably the protrusions are all substantially identical. For example, the protrusions may all be identical within manufacturing tolerances. This means that the surface microstructure can have uniform self-cleaning or other properties.

The protrusions may also comprise sets of protrusions of different dimensions or forms, for example, arranged as lines, regions and/or patterns of different types of protrusions, which overall provide the desired self-cleaning or other properties to the surface. There may be two, three, four or more different types of protrusion interspersed with one another. In some instances it may be desirable to provide a first region of the surface offering one property and a second region offering a second property through the selection of the type of protrusions.

Each protrusion may have an overall elongate form. For example, each protrusion may have a width between 100 and 300 nm and a length between 0.5 and 2 μm. Preferably each protrusion has a width of about 200 nm and a length of about 1.5 μm. It has been found that the microstructure has particularly good self-cleaning properties with these dimensions, although the optimised dimensions will depend on a number of factors such as the material of the protrusion, the angles of the protrusion relative to the surface, the shape of the protrusion, the environment in which it will typically operate and/or whether the protrusions comprise a support portion.

The protrusions may each have a constant width along the extending portion. Alternatively, the protrusions may each have a width which varies along its length. For example, the protrusion may decrease in width along its length and this may be to a point at the end of the extending portion of the protrusion (a free end of the protrusion). When the protrusion has a tapering width, the aforementioned width dimensions refer to the width of the extending portion at the end nearest the base portion.

The protrusion may have a rounded/curved free end. The protrusions may also have a rounded outer surface. The outer surface is preferably smooth and may include a coating of a hydrophobic material, such as a wax or oil.

The surface microstructure may comprise a thin coating with a wax or other hydrophobic material onto a solid structure (such as a pre-form etc.).

When viewed from above the surface, the base portion may appear wider than the extending portion. A single base portion may support a plurality of extending portions, i.e. a protrusion may comprise a single base portion and a plurality of extending portions. When the structure comprises support portions, a single support portion may support a plurality of base portions which may in turn support one or more extending portions.

If it is not clear what is meant by the length of the protrusion, the aforementioned length dimensions may refer to the length of each protrusion from the end of the protrusion nearest the surface to the end of the extending portion furthest from the base portion, when viewed from above the plane of the surface.

Each protrusion may have a length to width ratio of between 1:0.05 and 1:0.7. Preferably the length to width ratio is between 1:0.08 and 1:0.2, preferably about 1:0.1.

The height of each protrusion may be less than 5 μm and, when the protrusion does not comprise a support portion, preferably less than 2 μm, more preferably less than 1 μm. The height is defined as the distance from the surface to a point of the protrusion furthest from the surface.

The protrusions may be provided in an ordered manner. The plurality of protrusions may be an array of protrusions. For example, the protrusions may be provided in a plurality of rows or in a hexagonal or square array when viewed from above. When the protrusions are provided in a plurality of rows, the rows may be parallel to each other. The distance between each protrusion in a row may be between 0.1 and 10 μm. The rows may be separated by a gap of 0.1 to 10 μm, i.e. the distance between the end of the extending portion of a protrusion in one row and that the start of the base portion of the protrusion in the next row may be 0.1 to 10 μm. Alternatively, the end of the extending portion in one row may overlap part of a protrusion in the next row.

When the protrusions comprise a support structure, each support structure may be at least 0.1 μm from the adjacent support structures, i.e. there may be a gap of at least 0.1 μm between adjacent support structures. The distance between adjacent support structures may be between 0.1 and 10 μm and preferably 0.5 and 1 μm.

The protrusions may be formed so that there is a gap between the surface of the extending portion facing the surface and the surface. In other words the extending portion may be raised from the surface. Alternatively, the extending portion may be in direct contact with the surface, i.e. there is no gap between extending portion and the surface for a substantial portion of the protrusion's length. In this alternative the extending portions effectively lie against the surface.

The protrusions may be formed from a generally rigid material, such as a protein like keratin.

The protrusions may be formed from a polymer or plastics material such as polyethylene terephthalate (PET), polyamide, polytetrafluoroethylene (PTFE), polystyrene, polyurethane, polyolefin, polycarbonate, polyvinyl chloride, rubber, etc.

Alternatively the protrusions may be formed from other materials such as glass or metal. The material from which the protrusions are formed may be a natural materials or a man-made material. The material used to form the protrusions will depend on factors such as the application, the manufacturing method etc. Dirt particles can also be relatively abrasive, and accordingly, preferably the material of the protrusion is chosen with this in mind in order to provide a hard wearing, mud shedding surface for the article of clothing or, more preferably, item of footwear such as a sports shoe, in locations where dirt is likely to collect.

The surface to which the surface microstructure is applied may be a continuous flat surface such as the surface of an article such as a trainer. By flat surface it is meant that the surface is flat at a local level to the protrusion, i.e. the surface is flat within 100 μm of the protrusion. On a macro scale the surface may not be completely flat, e.g. it is likely to be curved. Preferably the surface is relatively smooth. Alternatively, the surface may be a fibre. In this case the fibre may be used to form an article, such as clothing which comprises the surface microstructure.

When viewing the surface microstructure from above, preferably over 40% of the surface is covered by the protrusions, more preferably greater than 50%. Preferably there are gaps between the protrusions and these may represent 20% or more of the area of the surface, more preferably greater than 30%.

The surface and the protrusions may be formed from the same material. In this case, the protrusions may be integral with the surface (as opposed to a separate component which is joined to the surface, such as by adhesive or welding).

The surface microstructure may be formed by any suitable method. For example, the protrusions may be stamped out of the surface (e.g. using a stamp applied to the surface to form the protrusions). The protrusions may be formed by etching into the surface or by using a process that removes material between the protrusions. The protrusions may be formed by weaving. Alternatively, the protrusions may be formed by melting the surface and pulling protrusions from the surface. If necessary to form the base portion and extending portion, the pulled protrusions may be flattened, such as by ironing, towards the surface. The protrusions may be formed as fibres and ironed to the desired shape and/or orientation relative to the surface.

The surface microstructure may be formed by depositing a material onto the surface to form the protrusions. For example, the protrusions may be made using 3D-printing.

The surface microstructure may be formed through a self-assembly technique. For example, a material may be applied to the surface, or the surface may comprise a material, which forms or coalesces to form the protrusions.

The surface microstructure may be formed by moulding.

In a third aspect, the present invention provides a method of manufacturing a surface microstructure, the method comprising: providing a surface; and providing a plurality of protrusions on the surface, wherein each of the protrusions has a base portion which extends away from the plane of the surface and an extending portion which extends in a direction which has a component parallel to the plane of the surface, and wherein the protrusions each have a length between 0.25 and 100 μm and a width between 0.1 and 1.5 μm.

The surface microstructure which is manufactured may have one or more of the optional features discussed above in relation to the first and second aspect of the invention.

The method may comprise applying the surface microstructure to an article, such as an item of clothing or an item of footwear.

The method may comprise stamping the protrusions out of the surface. The method may comprise depositing a material onto the surface to form the protrusions. The method may comprise moulding the protrusions.

The protrusions may be configured so that liquids are retained beneath the extending portions, e.g. by capillary forces. This means that the surface microstructure may be used to create a surface which enhances the retention of a liquid on the surface. The dimensions of the base portion, or more preferably the support portion, may be chosen, and the surface profile configured to promote capillary action in a liquid. This, for example, may be used on an article such as a scarf or a brooch to retain perfumes or on a bandage to retain antiseptics.

When the surface is super-hydrophobic, e.g. the microstructures which comprise hollow support structures, the structure may be applied to aid the floating or suspension of a relatively “dense” object on water. This for example, may be useful in apparatus for water sports and yachting equipment etc.

The present invention can be used in a large number of applications. Examples include shoes such as trainers, wellington boots, hiking boots, snowboard boots, ski boots, football, rugby, or American football boots etc., clothing such as coats, protective garments, overalls, contamination suits, sportswear, military, services, medical or other uniforms, yachting clothing etc., articles such as skis, snowboards, sledges, tyres, tents, garden buildings, garden furniture, carpets, upholstery, furniture, rucksacks, sleeping bags, umbrellas, walls, roofs, flooring, outdoor staging, contact lenses, medical equipment, etc., parts of vehicles such as aeroplanes, cars, vans, trucks, construction machinery, farm machinery, boats, bicycles, hovercrafts etc., engine parts, oil/petrochemical applications such as oil pipes, oil/petrochemical machines or devices, etc., and any other application in which a self-cleaning anti-microbe, anti-fouling and/or a super-hydrophobic surface would be of benefit.

One potential advantage of the mud-shedding properties of the surface microstructure could be that it helps minimise the spread of diseases. For example, the surface microstructure may be on the clothing or shoes (e.g. wellington boots) of a person, such as a farmer, so that mud may easily be washed off, thereby reducing the risk of spreading farm diseases.

The surface microstructure may be directly on the surface of the article (the article itself is processed to include the surface microstructure) or it may be on a material applied to the surface of the article.

Certain preferred embodiments of the present invention will now be described in greater detail, by way of example only, with reference to the accompanying drawings, in which:

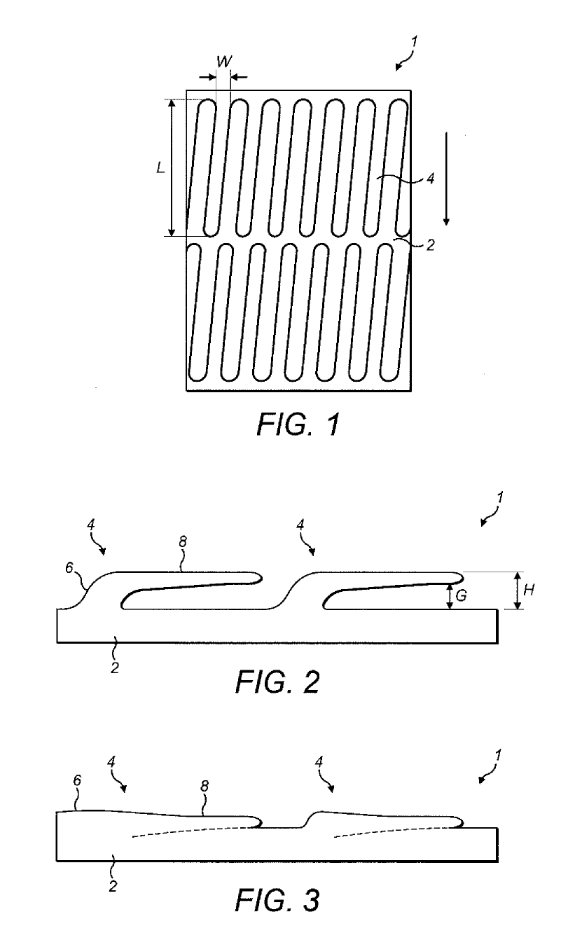

FIG. 1 shows a first example surface microstructure in plan view,

FIG. 2 shows the first example surface microstructure in side view,

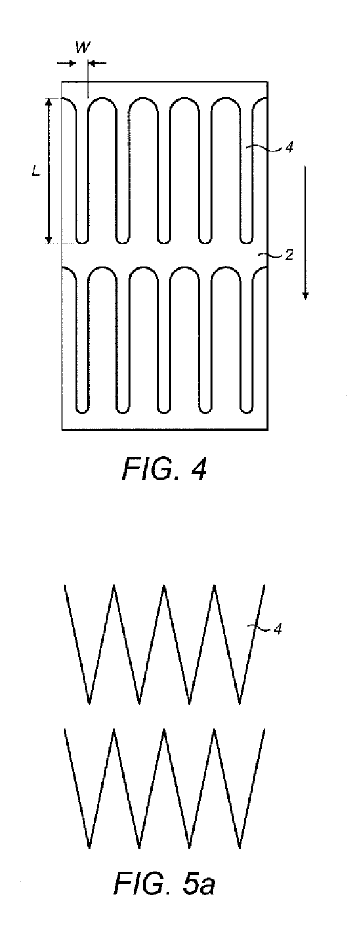

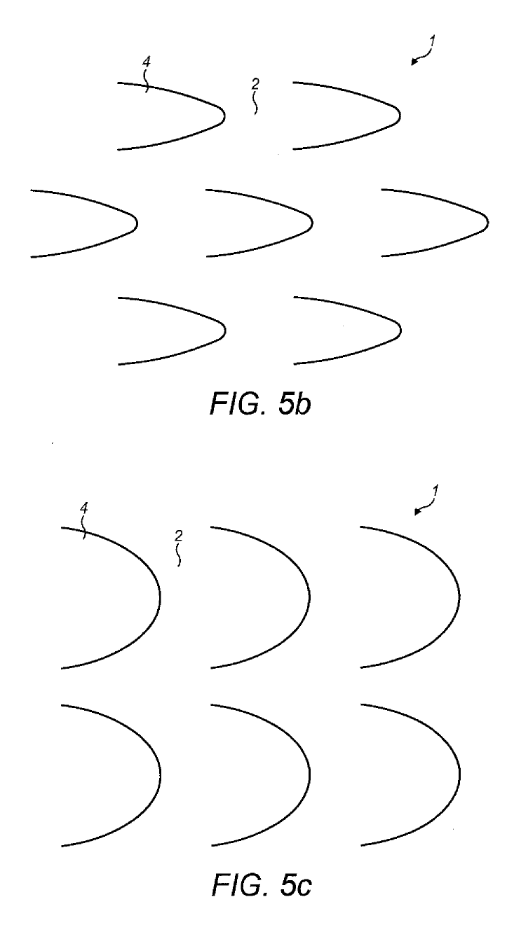

FIG. 3 shows a second example surface microstructure in side view,

FIG. 4 shows a third example surface microstructure in plan view,

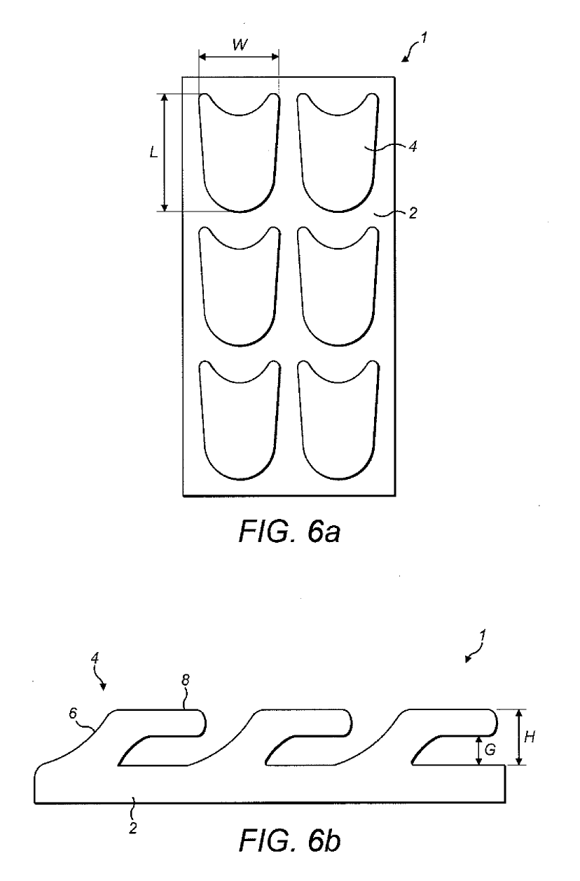

FIG. 5a to c show further example surface microstructures in plan view,

FIG. 6a shows a fourth example surface microstructure in plan view,

FIG. 6b shows the fourth example surface microstructure in side view,

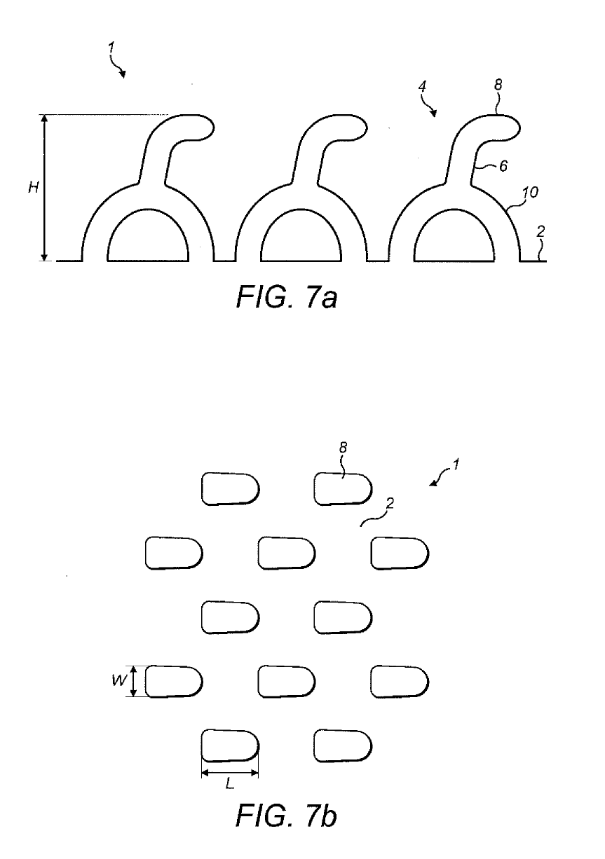

FIGS. 7a and 7b show a fifth example surface microstructure, and

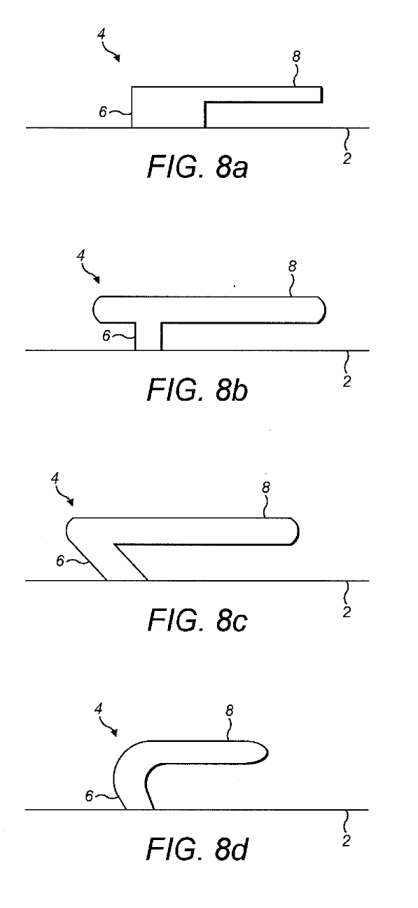

FIGS. 8a to d show further example protrusions.

FIG. 1 shows an example surface microstructure 1 which comprises a surface 2 and a plurality of protrusions 4. As shown most clearly in FIG. 2, each protrusion comprises a base portion 6 which extends out of the surface 2, connected to which is an extending portion 8 that extends substantially parallel to the plane of the surface 2.

The plurality of protrusions 4 are arranged in a plurality of rows (two rows are shown in FIG. 1). The protrusions 4 all extend in the same direction and are all substantially identical. The end of a protrusion 4 in one row is located about 100 nanometres before the start of a protrusion 4 in the next row.

Each protrusion has a length L, which in this example is about 1.5 μm, from the start of the base portion 6 to the end of the extending portion 8. Each protrusion has an approximately constant width W, which in this example is about 200 nm or 300 nm, from one side of the protrusion to the other side.

Each protrusion has a height H, which in this example is about 0.5 μm, from the top of the surface to the point of the protrusion furthest from the surface. There is a gap G between the surface and the underside of the extending portion 8 which faces the surface. This gap G may be of similar dimensions to the width of the extending portion 8, for example, between about 0.2-0.3 μm.

The surface microstructure 1 promotes mud shedding in damp conditions (by “mud shedding” this is intended to encompass all types of dirt particle, such as sand, clay or organic matter, etc. Dirt may be washed off the surface in the direction of the arrow shown in FIG. 1 thereby making the surface effectively self-cleaning. In many instances only a small amount of moisture will be necessary to facilitate the self-cleaning. The direction the dirt is washed off the surface is the same as the direction that the extending portions 8 of the protrusions 4 extend.

FIG. 3 shows a second example surface microstructure 1. This surface microstructure is the same as the surface microstructure of the first example shown in FIGS. 1 and 2 except that the extending portion 8 of the protrusions 4 is in contact with the surface 2, i.e. there is no gap G between the extending portion 8 and the surface 2.

This second example microstructure will be stiffer than the first example because of the way the extending portions are connected to the surface. It may have mud-shedding properties as with the first example, but the properties may be better suited to drier conditions.

FIG. 4 shows a third example microstructure. This is substantially the same as the first example except the dimensions of the protrusions 4 are different. In the third example the length L to width W ratio is greater. The length L in FIG. 4 may be as large as 100 μm and the width W may be as large as 1.5 μm.

FIGS. 5a to c show some of the possible variations in the arrangement and shape of the protrusions.

FIG. 5a shows an example in which the protrusions 4 taper in width along their length. As shown, the width of the protrusions 4 reduces along its length to a point, which could be a rounded point, at the end of the extending portion 8.

FIG. 5b shows an example in which the protrusions 4 are in a hexagonal array when viewed from above. The width of each protrusions 4 reduces along its length to a point, which is a rounded point, at the end of the extending portion 8.

FIG. 5c shows an example in which the protrusions 4 are arranged in rows. Each protrusion has a comparatively low width to length ratio and a large rounded end which corresponds to nearly the length of the extending portion 8.

FIGS. 6a and 6b show another example in which the protrusions 4 are again a different shape. The length L to width W ratio of the protrusions may be less, i.e. the width W is more similar to the length L, compared to some of the other example microstructures.

The protrusions 4 in this example have a shield like shape in plan view.

In fact, the protrusions 4 of the invention may have a variety of different shapes. Some of the possible variations in the protrusion shape are shown in cross section in FIGS. 8a to 8d.

FIGS. 7a and 7b show another example microstructure 1. In this example, each protrusion 4, comprises a support portion 10 in addition to the base portion 6 and the extending portion 8, i.e. a three-layered or three-tiered structure.

The support portion 10 is a hollow structure formed from legs which extend out of the plane of the surface 2 and are joined to form the support portion 10. Two legs are shown in FIG. 7a, however, there may be additional legs which extend into or out of the plane of the paper which are not shown in FIG. 7a because it is a cross-section.

The protrusions 4 are arranged in a hexagonal array when viewed from above as shown in FIG. 7b (only the extending portions 8 are shown in the figure). Alternatively the protrusions 4 may be in a square or random array when viewed from above.

A layer of wax, or other hydrophobic material, may be applied to the structure.

The form of the structure causes the surface to be super-hydrophobic.

All of the example surface microstructures exhibit advantageous self-cleaning properties, albeit to different extents.

1. A surface microstructure, the surface microstructure comprising:
a surface; and
a plurality of protrusions on the surface,
wherein each of the protrusions has a base portion which extends away from the plane of the surface and an extending portion which extends in a direction which has a component parallel to the plane of the surface,
wherein the protrusions each have a length between 0.25 and 100 μm and a width between 0.1 and 1.5 μm,
wherein the protrusion comprises a support portion between the surface and the base portion;
wherein each support portion defines a hollow structure, and
wherein the support portion comprise a plurality of legs which extend away from or out of the surface and are connected to define a hollow support structure.

2-4. (canceled)

5. A surface microstructure as claimed in claim 1, wherein the protrusions have a width between 100 and 300 nm and a length between 1 and 2 μm.

6. A surface microstructure as claimed in claim 1, wherein each protrusion has length to width ratio between 1:0.08 and 1:0.2.

7. A surface microstructure as claimed in claim 1, wherein the extending portion extends in a direction substantially parallel to the plane of the surface.

8. A surface microstructure as claimed in claim 1, wherein the base portion extends in a direction substantially perpendicular to the plane of the surface.

9. A surface microstructure as claimed in claim 1, wherein the extending portion is contiguous with the base portion.

10. A surface microstructure as claimed in claim 1, wherein the protrusions each have substantially the same dimensions, and wherein the extending portions of the protrusions all extend in the same direction.

11. (canceled)

12. A surface microstructure as claimed in claim 1, wherein all of the protrusions are substantially identical.

13. A surface microstructure as claimed in claim 1, wherein the height of each protrusion is less than 5 μm, preferably less than 2 μm.

14. A surface microstructure as claimed in claim 1, wherein the plurality of protrusions are arranged as a plurality of rows.

15. A surface microstructure as claimed in claim 1, wherein there is a gap between the under-surface of the extending portion and the surface.

16. A surface microstructure as claimed in claim 1, wherein the extending portion is in contact with the surface.

17. A surface microstructure as claimed in claim 1, wherein the protrusions are formed from a substantially rigid material.

18. A surface microstructure as claimed in claim 1, wherein the protrusions comprise a hydrophobic material.

19. A surface microstructure as claimed in claim 1, wherein the protrusions are integral with the surface.

20. A surface microstructure as claimed in claim 1, wherein the surface is a substantially flat continuous surface.

21. A surface microstructure as claimed in claim 1, wherein the surface is a surface of a fibre, and wherein the extending portion of each of the protrusions is parallel with the length of the fibre.

22. (canceled)

23. An article comprising a surface microstructure as claimed in claim 1.

24. An article as claimed in claim 23, wherein the article is an item of footwear.

25. A method of manufacturing a surface microstructure, the method comprising:
providing a surface; and
providing a plurality of protrusions on the surface,
wherein each of the protrusions has a base portion which extends away from the plane of the surface and an extending portion which extends in a direction which has a component parallel to the plane of the surface, and
wherein the protrusions each have a length between 0.25 and 100 μm and a width between 0.1 and 1.5 μm.

26-32. (canceled)
